(19) United States
(12) Patent Application Publication
(10) Pub. No.: US 2016/0139674 A1
(43) Pub. Date: May 19, 2016

(54) INFORMATION PROCESSING DEVICE, IMAGE PROJECTION DEVICE, AND INFORMATION PROCESSING METHOD

(71) Applicant: KABUSHIKI KAISHA TOSHIBA, Tokyo (JP)

(72) Inventors: Wataru WATANABE, Kawasaki (JP); Yuma SANO, Kawasaki (JP); Ryosuke NONAKA, Yokohama (JP); Masahiro BABA, Yokohama (JP)

(21) Appl. No.: 14/919,880

(22) Filed: Oct. 22, 2015

(30) Foreign Application Priority Data
Nov. 19, 2014 (JP) 2014-234981

(51) Int. Cl. G06F 3/01

(52) U.S. Cl. CPC G06F 3/017

(57) ABSTRACT

An information processing device includes a storage and an circuit. The storage stores first distance information indicating a distance between a reference point and a first surface and first shape information indicating a surface shape of the first surface. The circuit acquires second distance information indicating distance between the reference point and an object. The circuit determines if an operation inputted by user is present or absent by using the second distance information. The circuit determines whether a first condition is satisfied or not by comparing the first shape information with second shape information. The circuit updates the first distance information based on the second distance information when the operation is determined to be absent and the first condition is determined to be satisfied.

### CROSS-REFERENCE TO RELATED APPLICATIONS

This application is based upon and claims the benefit of priority from Japanese Patent Application No. 2014-234981, filed on Nov. 19, 2014; the entire contents of which are incorporated herein by reference.

### FIELD

Embodiments described herein relate generally to a device and a method that detect a distance to a surface.

### BACKGROUND

An information processing device has been developed for using a distance sensor to detect an operation by a pointer such as a finger. Such an information processing device has been combined with an image display such as a projector to develop an image processing device. For instance, detection of a touch operation on a projection surface is used to develop a technique for enabling an operation on a projection image as in a touch display.

A distance sensor can be used to detect a touch operation on an object surface. A proposed method for this technique is to detect the operation by comparing distance information acquired by the distance sensor with distance information (reference distance) between the distance sensor and the projection surface. Here, updating the reference distance is necessary for continuously detecting operations even after any change of positional relationship between the distance sensor and the projection surface.

There is demand for suitably updating the reference distance to improve the stability of the detection of operations.

### BRIEF DESCRIPTION OF THE DRAWINGS

FIG. 1 is a block diagram showing an information processing device;

FIG. 2 is a block diagram showing an updater;

FIG. 3 is a block diagram showing a variation of the information processing device shown in FIG. 1;

FIG. 4 is a block diagram showing an example of the updater of the embodiment;

FIG. 5 is a schematic perspective view illustrating an example of the information processing device in use;

FIG. 6 is a schematic perspective view illustrating an example of the information processing device in use;

FIGS. 7A and 7B are schematic perspective views for describing an example of the shape information;

FIGS. 8A to 8C are schematic perspective views for describing an alternative example of the shape information;

FIG. 9 is a flow chart showing an information processing method;

FIG. 10 is a block diagram showing an updater;

FIG. 11 is a schematic diagram showing operations executed by the determiner;

FIG. 12 is a flow chart showing an information processing method;

FIG. 13 is a block diagram showing an information processing device;

FIG. 14 is a schematic perspective view illustrating an example of the information processing device in use;

FIG. 15 is a schematic perspective view illustrating an example of the information processing device in use;

FIG. 16 is a schematic perspective view illustrating an example of the information processing device in use;

FIG. 17 is a block diagram showing an information processing device;

FIG. 18 is a block diagram showing an information processing device;

FIG. 19 is a block diagram showing an updater; and

FIG. 20 is a schematic perspective view illustrating an example of the information processing device in use.

### DETAILED DESCRIPTION

According to one embodiment, an information processing device includes a storage and a circuit. The storage stores first distance information indicating a distance between a reference point and a first surface and first shape information indicating a surface shape of the first surface. The circuit acquires second distance information indicating a distance between the reference point and an object. The circuit determines if an operation inputted by user is present or absent by using the second distance information. The circuit determines whether a first condition is satisfied or not by comparing the first shape information with second shape information. The circuit updates the first distance information based on the second distance information when the operation is determined to be absent and the first condition is determined to be satisfied.

Various embodiments will be described hereinafter with reference to drawings.

The drawings are schematic or conceptual. The relationship between the thickness and the width of each portion, and the size ratio between the portions, for instance, are not necessarily identical to those in reality. Furthermore, the same portion may be shown with different dimensions or ratios depending on the figures.

In this specification and the drawings, components similar to those described previously with reference to earlier figures are labeled with like reference numerals, and the detailed description thereof is omitted appropriately.

### First Embodiment

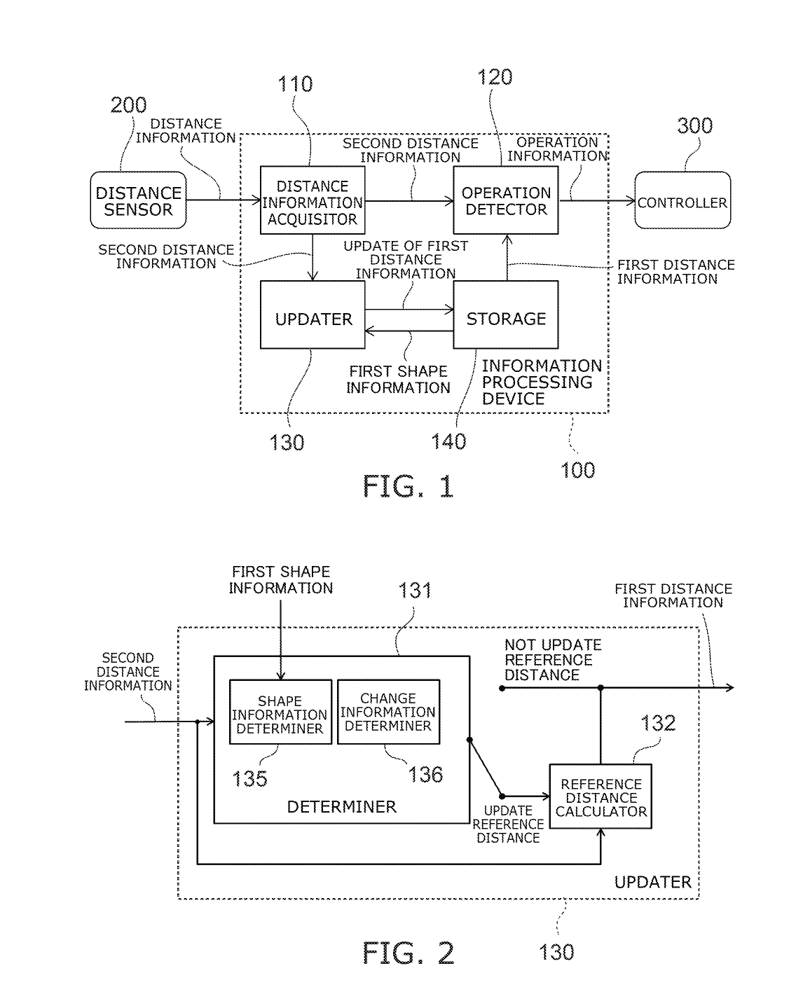

FIG. 1 is a block diagram showing an information processing device.

FIG. 2 is a block diagram showing an updater.

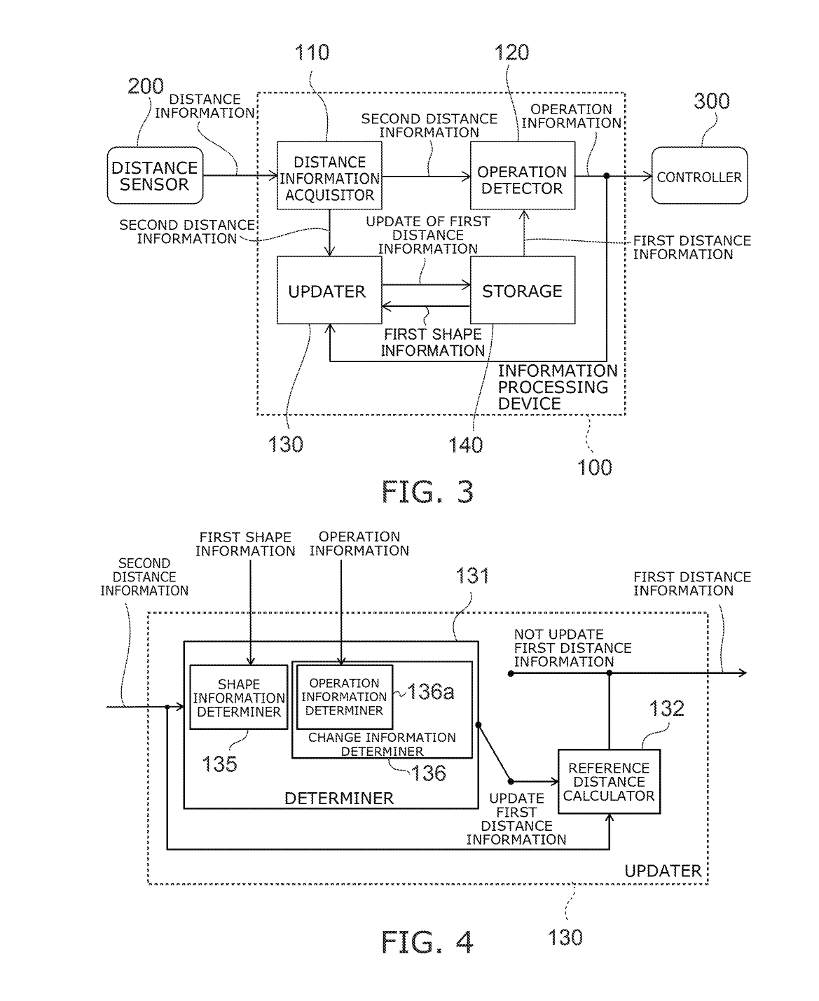

FIG. 3 is a block diagram showing a variation of the information processing device shown in FIG. 1.

FIG. 4 is a block diagram showing an example of the updater.

This embodiment relates to an information processing device for detecting an operation on an arbitrary object surface. The block diagram shown in FIG. 1 is an example of the configuration of the information processing device 100, and is not necessarily in agreement with the configuration of the actual program module. The block diagram shown in FIG. 2 is an example of the configuration of the updater 130, and is not necessarily in agreement with the configuration of the actual program module.

The information processing device 100 shown in FIG. 1 includes a distance information acquisitor 110, an operation detector 120, an updater 130, and a storage 140. As shown in FIG. 2, the updater 130 includes a determiner 131 and a reference distance calculator 132. The determiner 131 includes a shape information determiner 135 and a change information determiner 136. As shown in FIG. 4, the change information determiner 136 includes e.g. an operation information determiner 136a. In this embodiment, the information processing device 100 is connected to peripheral devices including a distance sensor 200 (distance measurer) and a controller 300.

The distance sensor 200 and the controller 300 can be external devices different from the information processing device 100. Alternatively, the information processing device 100 may include the distance sensor 200 and the controller 300. The distance sensor 200 and the controller 300 may be incorporated in the display 500 described later. The controller 300 is e.g. a computer. The hardware configuration shown in FIG. 1 is an example. Part or all of the information processing device can be implemented as an integrated circuit such as LSI (large scale integration), or an IC (integrated circuit) chip set. Each functional block may be separately configured as a processor. Alternatively, part or all of the functional blocks may be integrated into a processor. The integrated circuit is not limited to LSI, but the functional blocks may be configured as an integrated circuit using a dedicated circuit or general-purpose processor.

The distance sensor 200 measures the distance between a reference point and a first surface separated from the reference point. The distance sensor 200 outputs the measured distance information to the distance information acquisitor 110. The reference point is e.g. the origin of the distance sensor 200. The first surface is e.g. a surface defining the target of operation detection. The first surface includes e.g. a projection surface on which an image is projected.

The distance information acquisitor 110 acquires, and e.g. holds, the distance information measured by the distance sensor 200. In this specification, the distance information acquired from the distance sensor 200 by the distance information acquisitor 110 is referred to as “second distance information”. That is, the second distance information is the distance information acquired by the distance information acquisitor 110. The second distance information may include distance information at a plurality of past times. The second distance information is information on the distance between the reference point and an object separated from the reference point. The “object” herein refers to an object that can be contained in the angle of view of the distance sensor 200 during operation. The “object” referred to herein is an object such as a pointer, a projection surface, and a person traversing between the distance sensor 200 and the first surface.

The operation detector 120 receives the second distance information from the distance information acquisitor 110. The operation detector 120 detects an operation on the projection surface using the received second distance information and the reference distance (first distance information) described later. The reference distance (first distance information) is information on the distance between the reference point and the first surface separated from the reference point.

The updater 130 receives the second distance information from e.g. the distance information acquisitor 110. Furthermore, the updater 130 receives shape information (first shape information) stored by the storage 140. The details of the first shape information will be described later. The updater 130 appropriately updates the reference distance (first distance information) stored in the storage 140 based on the second distance information and the first shape information.

The operation detector 120 detects an operation based on the updated reference distance.

The controller 300 receives information on the operation state (operation information) and the reference distance. The controller 300 performs processing such as changing the image based on the received information.

As shown in FIG. 3, the updater 130 may receive the operation information from the operation detector 120. In the example shown in FIG. 3, the updater 130 appropriately updates the reference distance (first distance information) stored in the storage 140 based on the second distance information, the first shape information, and the operation information.

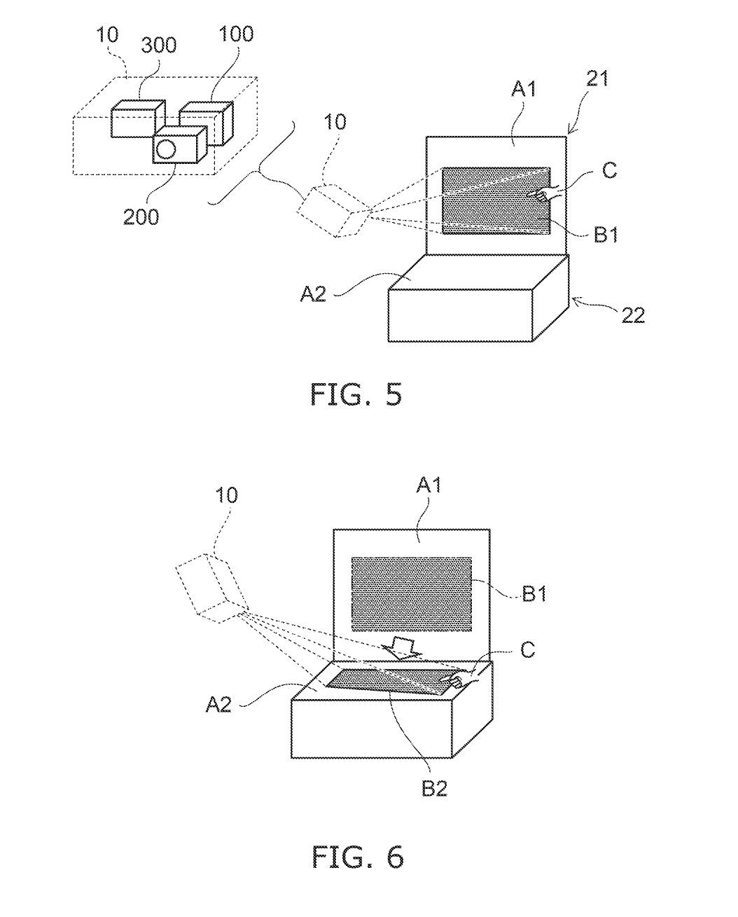

FIGS. 5 and 6 are schematic perspective views illustrating an example of the information processing device in use.

This example is described assuming that the information processing device 100, the distance sensor 200, and the controller 300 are included in one casing 10. However, this embodiment is not limited thereto. The information processing device 100 and the controller 300 may be placed at remote locations, respectively.

This embodiment is described assuming that the distance sensor 200 is a distance image sensor capable of two-dimensionally acquiring distance information to a target object. An ordinary camera acquires color information of an imaged target as a two-dimensional array, i.e., an image. Likewise, the distance image sensor can acquire the distance to an imaged target as a two-dimensional array (distance image). The method for acquiring a distance image can be based on e.g. an infrared pattern irradiation scheme or a time-of-flight scheme. In the infrared pattern irradiation scheme, the target is irradiated with an infrared pattern. The pattern is detected by an infrared camera. The distance is measured by triangulation. In the time-of-flight scheme, light is projected on the target. The distance is measured by measuring the round-trip time of the light. The distance sensor 200 may be a sensor using other distance acquisition methods. The distance information (second distance information) acquired from the distance image sensor by the distance information acquisitor 110 is denoted by d(x,y,t). Here, x and y represent the image coordinates of the distance image, and t represent the acquisition time.

The distance information acquisitor 110 acquires and holds the distance information continuously acquired by the distance sensor 200. This embodiment is described assuming that the distance information acquisitor 110 acquires and holds a plurality of pieces of distance information at mutually different times. That is, in this embodiment, the second distance information functions as a buffer including a plurality of pieces of distance information at mutually different times.

The object 21 shown in FIG. 5 has a surface A1. The object 22 has a surface A2. Each of the surface A1 and the surface A2 is an object surface (first surface) that can be subjected to operation detection. For instance, the surface A1 is a wall surface. For instance, the surface A2 is a desk surface. This embodiment is described assuming that the object surface subjected to operation detection is a plane. However, this embodiment is not limited thereto. In the embodiment, the object surface may be a nonflat surface including irregularities.

The measurement range B1 shown in FIG. 5 represents the range in which the distance sensor 200 measures the distance. The pointer C is an object such as a finger or a pointing bar. An operation is performed by the pointer C on the object such as the surface A1 or the surface A2. An operation by the pointer C in the measurement range B1 is detected in this embodiment. The measurement range B1 may use all or part of the angle of view of the distance sensor 200.

Here, the distance information in the case where no obstacle other than the object surface subjected to operation detection exists between the distance sensor 200 and the object surface included in the measurement range B1 is referred to as reference distance D₀(x,y).

The operation detector 120 detects an operation using the reference distance D₀(x,y) and the second distance information d(x,y,t). For instance, the operation detector 120 detects the presence of an operation based on the difference between the reference distance D₀(x,y) and the second distance information d(x,y,t) when the difference falls within a range. A touch operation on the object surface by the pointer C such as a finger and a pen is detected in this embodiment. However, this embodiment is not limited thereto. In the embodiment, any kind of operation may be detected as long as the operation can be detected based on the distance information.

The distance to the object surface (reference distance D₀(x,y)) is known. Thus, the location of the pointer C touching the object surface can be determined by the following equation.

$$\begin{matrix}[ Eq . 1 ] & \\ Near ( x , y ) = \{ \begin{matrix}1 & {D}_{0} ( x , y ) - {D}_{margin} ( x , y ) \leq d ( x , y , t ) \leq {D}_{0} ( x , y ) + {D}_{margin} ( x , y ) \\ 0 & otherwise\end{matrix} & ( 1 )\end{matrix}$$

Here, D_{margin}(x,y) is a parameter for detection. By suitably setting the parameter, it can be regarded that a touch operation by the pointer C is performed at the position of coordinates (x,y) if Near(x,y)=1.

When a touch by the pointer C with a certain thickness such as a finger and a pen occurs, the region on which the operation such as a touch is performed is detected as a connected region of pixels with Near(x,y)=1.

When a plurality of points (regions) on the object surface are touched, the number of touched points can be the number of connected regions. The barycenter coordinates of each connected region can be used as the coordinates of the touched region. Here, the region having a small number of connected components with Near(x,y)=1, i.e., the region having a small area of the connected region, may be rejected. This can suppress influence due to e.g. noise included in the distance information to determine the operation.

The number of the detected connected regions (touch point number) and the coordinates of the connected region (touch coordinates) are outputted as operation information to the controller 300. In this embodiment, the operation information is set to “During operation” when the number of connected regions is one or more. The operation information is set to “Operation not performed” when the number of connected regions is zero. In the example shown in FIG. 3, such operation information is outputted to the updater 130.

The controller 300 determines the operation based on the operation information detected by the operation detector 120. For instance, the controller 300 performs e.g. processing for issuing a touch event or a flick operation based on the touch coordinates and the touch point number.

FIG. 6 shows the state in which the position or orientation (position posture) of the casing 10 has changed. With the change of the position or orientation of the casing 10, the measurement range B1 changes to a measurement range B2.

When the position posture of the casing 10 has changed like this, it is desirable to automatically update the reference distance D₀(x,y) in accordance therewith. Thus, the object surface subjected to operation detection is changed to the surface A2.

For instance, the reference distance D₀(x,y) is updated when the distance between the object surface subjected to operation detection and the casing 10 has changed. That is, the reference distance D₀(x,y) is updated not only when the position posture of the casing 10 has changed, but also when the position posture of the object surface or the shape of the object surface has changed.

The change of the position posture of the casing 10 alone can be detected by providing e.g. an acceleration sensor on the casing 10. However, the change of the position posture of the object surface or the change of the shape of the object surface cannot be detected using only the signal of the acceleration sensor provided on the casing 10. The change of the position posture of the object surface includes e.g. the movement of the position of the object surface.

The change of the position posture of the casing 10, the change of the position posture of the object surface, and the change of the shape of the object surface can be detected using the temporal change of the distance information such as time difference of the distance information. However, the distance information changes also by the operation by the pointer C. For instance, the distance information changes when the pointer C is placed between the object surface subjected to operation detection and the distance sensor 200 in the distance measurement range. It is not easy to distinguish the change of position posture from the change due to the pointer C using only the distance information. If the reference distance D₀(x,y) is updated using only the distance information, the pointer C for operation may be included in the reference distance.

Thus, in this embodiment, a condition for updating the reference distance is established. The reference distance is updated when the condition is satisfied. As described above with reference to FIGS. 1 to 4, the information processing device 100 according to this embodiment includes an updater 130 and a storage 140. The updater 130 includes a determiner 131 and a reference distance calculator 132. The determiner 131 includes a shape information determiner 135 and a change information determiner 136.

The storage 140 stores the reference distance D₀(x,y). The determiner 131 determines whether the condition for updating the reference distance D₀(x,y) is satisfied. The reference distance calculator 132 calculates a new reference distance different from the reference distance stored in the storage 140 when the condition for updating the reference distance D₀(x,y) is satisfied.

The shape information determiner 135 calculates information on the shape of the object surface as second shape information based on the second distance information received from the distance information acquisitor 110. The shape information determiner 135 determines whether a condition as a shape of the object surface (first condition) is satisfied based on the second shape information. In this embodiment, it is determined whether the first condition is satisfied by comparing the shape information (first shape information) previously stored in the storage 140 with the second shape information. The shape information stored by the storage 140 is referred to as first shape information. The shape information calculated by the shape information determiner 135 based on the second distance information is referred to as second shape information. The first shape information is information on the surface shape of the first surface.

For instance, the first condition is a condition on whether the degree of similarity between the first shape information and the second shape information is more than or equal to a certain degree. For instance, the first shape information is a threshold of the degree of similarity between a predetermined shape and the second shape information. The second shape information is information on the shape of the object surface calculated based on the second distance information. When the degree of similarity between the predetermined shape and the second shape information is more than or equal to the threshold, the shape information determiner 135 determines that the condition of the shape of the object surface is satisfied.

Next, an example of the shape information is described.

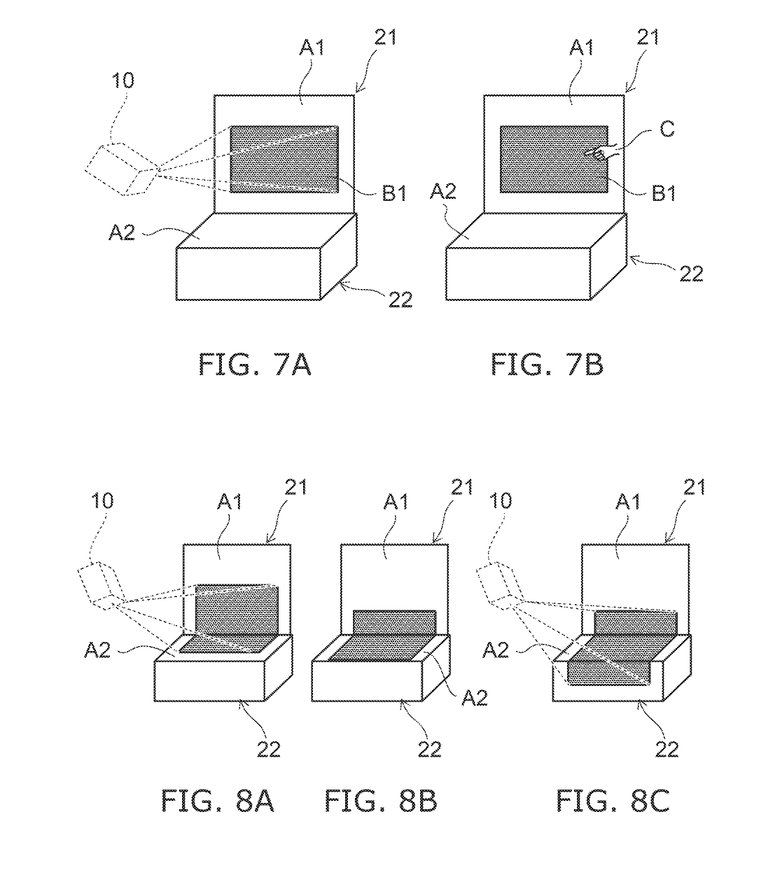

FIGS. 7A and 7B are schematic perspective views for describing an example of the shape information.

FIGS. 8A to 8C are schematic perspective views for describing an alternative example of the shape information.

FIG. 7A is a schematic perspective view showing the state before a pointer is brought close to the object surface. FIG. 7B is a schematic perspective view showing the state after the pointer is brought close to the object surface.

FIG. 8A is a schematic perspective view showing the state before the position posture of the casing changes. FIG. 8B is a schematic perspective view showing an example of the state after the position posture of the casing has changed. FIG. 8C is a schematic perspective view showing an alternative example of the state after the position posture of the casing has changed.

In the case where the shape of the object surface is flat, the object surface calculated by the shape information determiner 135 based on the second distance information is used as second shape information. In this case, the first shape information represents e.g. a threshold of flatness. The second shape information represents e.g. flatness.

The flatness is calculated based on the fitting error of the object surface. The fitting error is e.g. the error in applying plane fitting to the second distance information received by the shape information determiner 135 from the distance information acquisitor 110. Alternatively, the flatness may be calculated as follows. The second distance information received by the shape information determiner 135 from the distance information acquisitor 110 is converted to a three-dimensional point cloud. This is subjected to eigenvalue decomposition. The flatness may be calculated based on the ratio between the maximum eigenvalue and the minimum eigenvalue among the decomposed eigenvalues. Alternatively, the flatness may be calculated using any known means as long as it is an index taking a larger value when the shape based on the second distance information received by the shape information determiner 135 from the distance information acquisitor 110 is closer to a plane, and taking a smaller value with deviation from a plane.

The shape information determiner 135 determines that the condition of the shape is satisfied when the calculated flatness is higher than a threshold. For instance, as shown in FIGS. 7A and 7B, the pointer C is brought close to the object surface before and after the operation. In this case, the shape of the object surface deviates from a plane compared with that before the pointer C is brought close to the object surface. Thus, the flatness of the object surface decreases. The first shape information may be set so that the case of including the pointer C can be distinguished from the case of not including the pointer C. Then, it is possible to avoid updating the reference distance when the pointer C lies in the measurement range B1.

As shown in FIGS. 8A to 8C, in the case where the object surface includes a multiple planes, the shape information may be the number of surfaces. In this case, the first shape information is the number of surfaces (first surfaces) included in the object surface. The second shape information is the number of surfaces (second surfaces) in the case where the second distance information is approximated by a multiple planes. For instance, as shown in FIG. 8A, operation detection may be performed on the object surface composed of a maximum of two planes. In this case, the shape information determiner 135 can determine that the condition of the shape is satisfied when the number of approximated surfaces is two or less (in the case of the example shown in FIG. 8B), and that the condition is not satisfied when the number of approximated surfaces is three or more (in the case of the example shown in FIG. 8C). For instance, using the number of surfaces as shape information is one of the useful means in e.g. the case of detecting an operation even when the acquisition range of the distance information includes corners of surfaces.

Alternatively, the shape information may be the size of the area of the plane approximation of the object surface. Alternatively, the shape information may be the angle of the object surface or the average distance of the object surface. Alternatively, in the case where the object surface is not a plane but a curved surface, the shape information may be the curvature of the surface.

Alternatively, the shape information may be three-dimensional shape information itself in order to respond to an object having a more complex shape. For instance, three-dimensional point cloud data (first point cloud data) of the object surface is previously measured and registered as first shape information in the storage 140. The shape information determiner 135 reconstructs the three-dimensional point cloud data (second point cloud data) of the object based on the second distance information received from the distance information acquisitor 110. The three-dimensional point cloud data is used as second shape information. The shape information determiner 135 can respond to an object having a complex shape by determining whether the condition of the shape of the object surface is satisfied when the similarity between the two point cloud data is more than or equal to a threshold.

Next, the change information determiner 136 is described.

The change information determiner 136 determines conditions based on the time change (temporal change) of the second distance information received from the distance information acquisitor 110. In this embodiment, the time change calculated from the second distance information is the change of the touch operation state detected by the operation detector 120.

The following illustrates an example (the example shown in FIGS. 3 and 4) in which the change information determiner 136 makes a determination based on the change of the operation information detected by the operation detector 120. FIG. 4 shows a block diagram in the case where the change information determiner 136 determines the change information based on the change of the operation information. As shown in FIG. 4, the change information determiner 136 includes an operation information determiner 136a. In this embodiment, the operation information determiner 136a determines whether an operation has occurred based on the operation information. When no operation has occurred, the operation information determiner 136a determines that the condition as a projection surface is satisfied.

Specifically, when the touch point number detected by the operation detector 120 is zero points, the operation information determiner 136a determines that the condition is satisfied. On the other hand, when the touch point number is at least one, a pointer is touching the object surface. Thus, the operation information determiner 136a determines that the condition for updating the reference distance is not satisfied. That is, the operation information determiner 136a determines the presence or absence of an operation.

The determiner 131 integrates the determination result of the shape information determiner 135 and the determination result of the change information determiner 136 to determine whether to update the reference distance. For instance, the determiner 131 determines to update the reference distance when the determination results of both the shape information determiner 135 and the change information determiner 136 satisfy the condition. Alternatively, the determiner 131 may determine to update the reference distance when the determination result of one of the shape information determiner 135 and the change information determiner 136 satisfies the condition. That is, the determiner 131 determines to update the reference distance when the determination result of at least one of the shape information determiner 135 and the change information determiner 136 satisfies the condition.

The reference distance calculator 132 recalculates the reference distance D₀(x,y) from the second distance information of at least one or more times held in the distance information acquisitor 110. In other words, the reference distance calculator 132 recalculates the reference distance D₀(x,y) based on the second distance information received from the distance information acquisitor 110. Here, the time of update is denoted by t _{update}. The simplest method for calculating the reference distance D₀(x,y) is to set the reference distance as D₀(x,y)=d(x,y,t_{update}).

The reference distance calculator 132 may determine the reference distance D₀(x,y) from a plurality of pieces of second distance information held in the distance information acquisitor 110. The plurality of pieces of second distance information are a plurality of pieces of distance information at mutually different times. For instance, the reference distance calculator 132 can use e.g. the average, mode, median, minimum, or maximum of second distance information at a plurality of times. Thus, the reference distance calculator 132 can suppress the influence due to e.g. noise included in the distance information to determine the reference distance D₀(x,y).

The storage 140 holds the reference distance D₀(x,y) and the first shape information. When it is determined to update the reference distance D₀(x,y) by the updater 130, the reference distance D₀(x,y) stored by the storage 140 is updated by the updater 130.

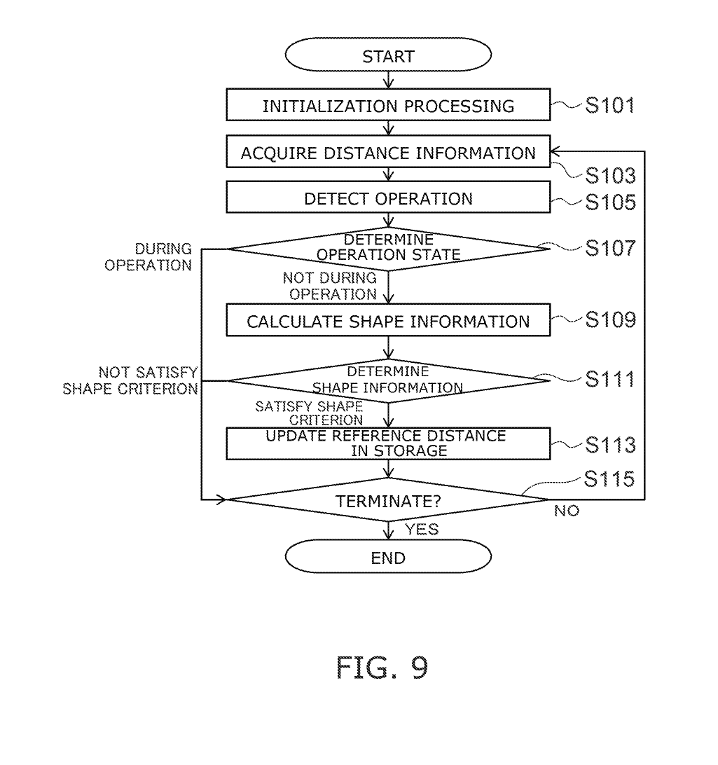

FIG. 9 is a flow chart showing an information processing method.

In the flow chart shown in FIG. 9, the operation detector 120 acquires second distance information from the distance information acquisitor 110. The operation detector 120 detects an operation by comparing the reference distance with the second distance information. Then, the determiner 131 determines whether to update the reference distance based on the condition related to the state of operation and the condition related to the information of shape (first condition). The updater 130 updates the reference distance stored in the storage 140 when it is determined that there is no operation and the first condition is satisfied.

Referring to the flow chart shown in FIG. 9, an initialization processing is first performed (step S101). The reference distance and the first shape information stored by the storage 140 are initialized by prescribed values at the time of initialization processing. With regard to the reference distance, the configuration may be such that the reference distance is updated at one time initially e.g. after startup of the information processing device 100. However, the update condition may not be satisfied at the time of initialization processing. For instance, a pointer C has been placed near the object surface since before the initialization processing. Then, a misdetection may occur in the operation detector 120 if the reference distance is forcibly initialized. In this case, the determiner 131 may make a determination also at the time of initialization processing. When the condition is not satisfied, for instance, an alert processing may be performed to prompt the user to a correct initialization.

Next, the operation detector 120 acquires second distance information from the distance information acquisitor 110 (step S103). The operation detector 120 detects an operation by comparing the reference distance with the second distance information (step S105).

Next, the operation information determiner 136a determines the operation state (determines the presence or absence of an operation) based on the operation information received from the operation detector 120 (step S107). When the operation information determiner 136a determines that the operation state is not during operation (step S107: “NOT DURING OPERATION”), the shape information determiner 135 calculates second shape information (step S109). On the other hand, when the operation information determiner 136a determines that the operation state is during operation (step S107: “DURING OPERATION”), it is determined whether to terminate the operation (step S115).

Next, based on the first shape information stored in the storage 140, the shape information determiner 135 determines the second shape information calculated by the shape information determiner 135 (determines whether the first condition is satisfied) (step S111). When the shape information determiner 135 determines that the second shape information satisfies the shape criterion (step S111: “SATISFY SHAPE CRITERION”), the updater 130 updates the reference distance stored in the storage 140 (step S113). On the other hand, the shape information determiner 135 determines that the second shape information does not satisfy the shape criterion (step S111: “NOT SATISFY SHAPE CRITERION”), it is determined whether to terminate the operation (step S115).

According to this embodiment, the reference distance is updated when at least one of the shape of the object surface and the operation state by a pointer satisfies the condition. On the other hand, the reference distance is not updated during operation by a pointer or when an obstacle such as a pointer C is included between the distance sensor 200 and the object surface before and after the operation. Thus, the information processing device 100 according to this embodiment can update the reference distance more favorably. Accordingly, the information processing device 100 according to this embodiment can improve the stability of the detection of operations. In other words, the information processing device 100 according to this embodiment can provide a stabler operation to the user.

### Second Embodiment

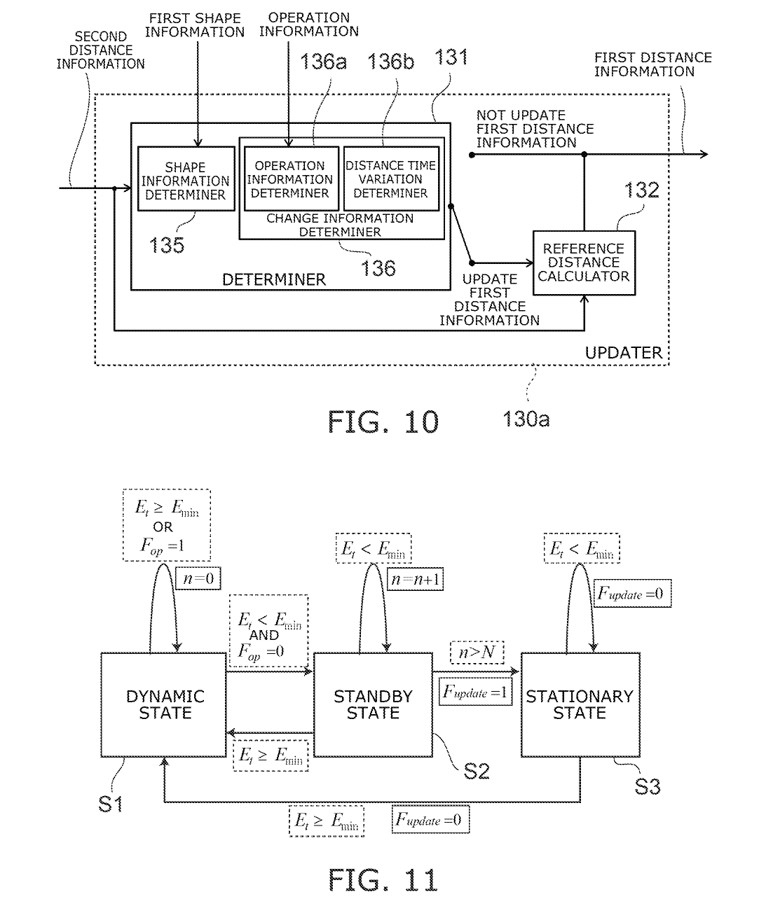

FIG. 10 is a block diagram showing an updater.

This embodiment relates to an information processing device for detecting an operation on an arbitrary object surface. The updater 130a of the second embodiment is different from the updater 130 of the first embodiment in further including a distance time variation determiner 136b. The distance time variation determiner 136b makes a determination using the time change amount of the distance between the distance sensor 200 and the object surface as a condition (third condition). In the following, description of the portions acting similarly to those of the first embodiment is omitted.

The distance time variation determiner 136b calculates the temporal change amount of the distance information. In this embodiment, the distance change amount is defined by the following equations.

[Eq. 2]

Eₜ=(εₜ−εₜ₋₁)² (2)

$$\begin{matrix}[ Eq . 3 ] & \\ {ɛ}_{i} = \frac{1}{{N}_{ROI}} {\sum }_{( x , y ) ∈ ROI}^{ } \vert d ( x , y , t ) - d ( x , y , t - 1 ) \vert & ( 3 )\end{matrix}$$

ROI represents a set of pixels used to calculate the distance change amount in the acquired distance image. N_{ROI} represents the number of pixels included in ROI.

The method for calculating the distance change amount is not limited thereto. The distance change amount may be based on any other calculation means as long as it is an index capable of representing the magnitude of change between the distance information acquired at mutually different times. For instance, the method for calculating the distance change amount may be a simple method using the absolute value of the difference or a method of comparing the histogram of distance values.

The distance time variation determiner 136b determines that the update condition (third condition) is satisfied when the distance change amount Eₜ is less than or equal to a threshold. In this embodiment, as described below, the change information determiner 136 determines whether to update the reference distance by referring to both the operation information detected by the operation detector 120 and the distance change amount calculated by the distance time variation determiner 136b. In this embodiment, the updater 130a updates the reference distance D₀(x,y) when the time change amount of the distance information (distance change amount Eₜ) is small and the state with no operation has continued for a certain period.

FIG. 11 is a schematic diagram illustrating operations executed by the determiner.

FIG. 11 is a state transition diagram showing the determination process of the determiner 131. As shown in FIG. 11, there are e.g. three states: “dynamic state S1”, “standby state S2”, and “stationary state S3”. Each state transitions between the states under the condition enclosed with the dashed line. The processing enclosed with the solid line is performed at the time of state transition.

In the following, the flow of state transition is described with reference to FIG. 11. Eₘᵢₙ (reference value) is a threshold determining the magnitude of the distance change amount. Fₒₚ is a binary variable determined from the operation information. Fₒₚ=1 represents the state during operation. Fₒₚ=0 represents the state with no operation performed. F_{update} is an output of the determiner 131. The updater 130a updates the reference distance if F_{update}=1. The updater 130a does not update the reference distance if F_{update}=0.

In the following description, it is assumed that the initial state is the “dynamic state S1”. When the distance change amount is more than or equal to the threshold (Eₜ≧Eₘᵢₙ), or during operation (Fₒₚ=1), the state remains in the “dynamic state S1”.

Here, n is a counter for state transition. While the state remains in the “dynamic state S1”, n=0.

When the distance change amount is less than the threshold (Eₜ<Eₘᵢₙ) and no operation is performed (Fₒₚ=0), the state transitions from the “dynamic state S1” to the “standby state S2”. When the distance change amount is less than the threshold, the state remains in the “standby state S2”, and the counter n increases. When the distance change amount becomes more than or equal to the threshold during the “standby state S2”, the state transitions to the “dynamic state S1”, and the counter n is reset to zero.

When the counter n increases to n>N, the state transitions from the “standby state S2” to the “stationary state S3”. At this time, the determiner 131 sets F_{update}=1 and determines to update the reference distance. When the distance change amount is less than the threshold, the state remains in the “stationary state S3”. When the distance change amount is more than or equal to the threshold, the state transitions to the “dynamic state S1”. In any case, F_{update} is set to F_{update}=0.

Thus, the change information determiner 136 determines that the update condition (third condition) of the reference distance D₀(x,y) is satisfied when the time change amount of the distance information is small and the state with no operation has continued for a certain period.

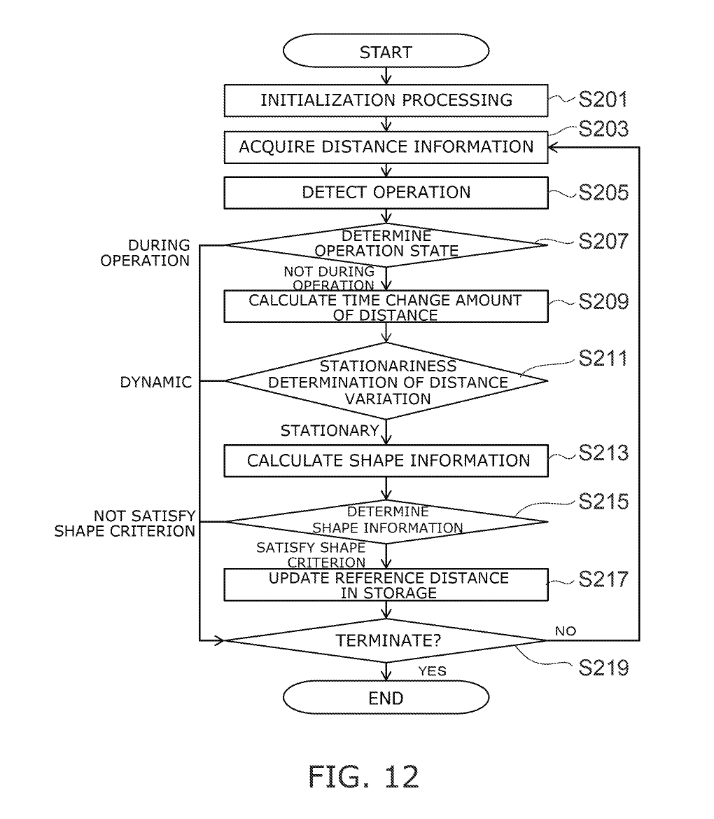

FIG. 12 is a flow chart showing an information processing method.

In the flow chart shown in FIG. 12, the mutual order of the determination of operation information (step S207: determination of the presence or absence of an operation), the stationariness determination of distance variation (step S211), and the determination of shape information (step S215: determination of the first condition) is not limited to the order illustrated in FIG. 12. Here, the computation cost of the determination of shape information (step S215) is higher than that of the determination of operation information (step S207) and the stationariness determination of distance variation (step S211). Thus, the computation cost can be reduced by calculating and determining the shape information after the processing for the stationariness determination of distance variation (step S211) is performed and it is determined that the state is the stationary state.

First, steps executed in S201-S207 are similar to the steps S101-S107 described in FIG. 9.

Next, when the operation information determiner 136a determines that the operation state is not during operation (step S207: “NOT DURING OPERATION”), the distance time variation determiner 136b calculates the time change amount of the distance information (step S209). On the other hand, when the operation information determiner 136a determines that the operation state is during operation (step S207: “DURING OPERATION”), it is determined whether to terminate the operation (step S219).

Next, the distance time variation determiner 136b performs stationariness determination of distance variation (distance change) (step S211). When the distance time variation determiner 136b determines that the state is the “stationary state S3” (step S211: “STATIONARY”), the shape information determiner 135 calculates second shape information (step S213). On the other hand, when the distance time variation determiner 136b determines that the state is the “dynamic state S1” (step S211: “DYNAMIC”), it is determined whether to terminate the operation (step S219).

Next, the operations of steps S215-S219 are similar to the operations of steps S111-S115 described in FIG. 9.

### Third Embodiment

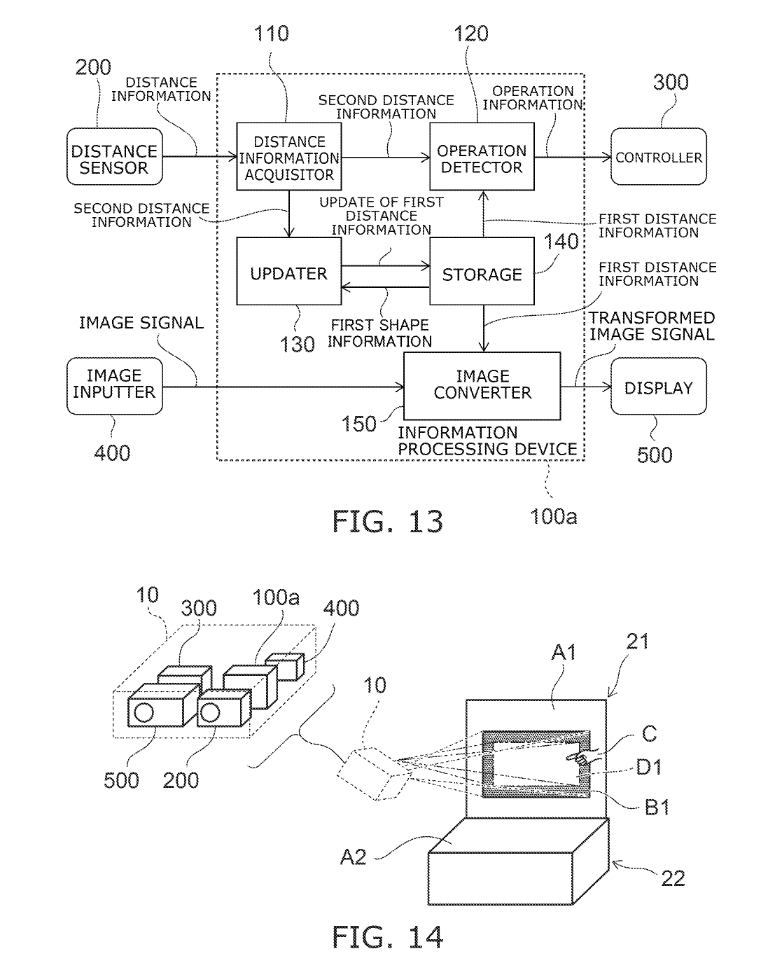

FIG. 13 is a block diagram showing an information processing device.

This embodiment relates to an information processing device for deforming an image in order to display the image on an arbitrary object surface without distortion, and detecting an operation on the displayed image.

The information processing device 100a according to this embodiment is different from the information processing device 100 according to the first and second embodiments in further including an image converter 150. This embodiment is described assuming that the information processing device 100a is connected to a distance sensor 200, a controller 300, an image inputter 400, and a display 500 as peripheral devices. In the embodiment, these peripheral devices are provided as necessary.

This embodiment is described below. For convenience, description of the portions acting similarly to those of the first embodiment and the second embodiment is omitted, and the portions with different operation are described.

FIGS. 14 to 16 are schematic perspective views illustrating an example of the information processing device in use.

As shown in FIG. 14, this embodiment is described assuming that the information processing device 100a, the distance sensor 200, the controller 300, the image inputter 400, and the display 500 are included in one casing 10. However, the embodiment is not limited thereto. In the embodiment, the information processing device 100a, the controller 300, and the image inputter 400 may be placed at mutually remote locations, respectively.

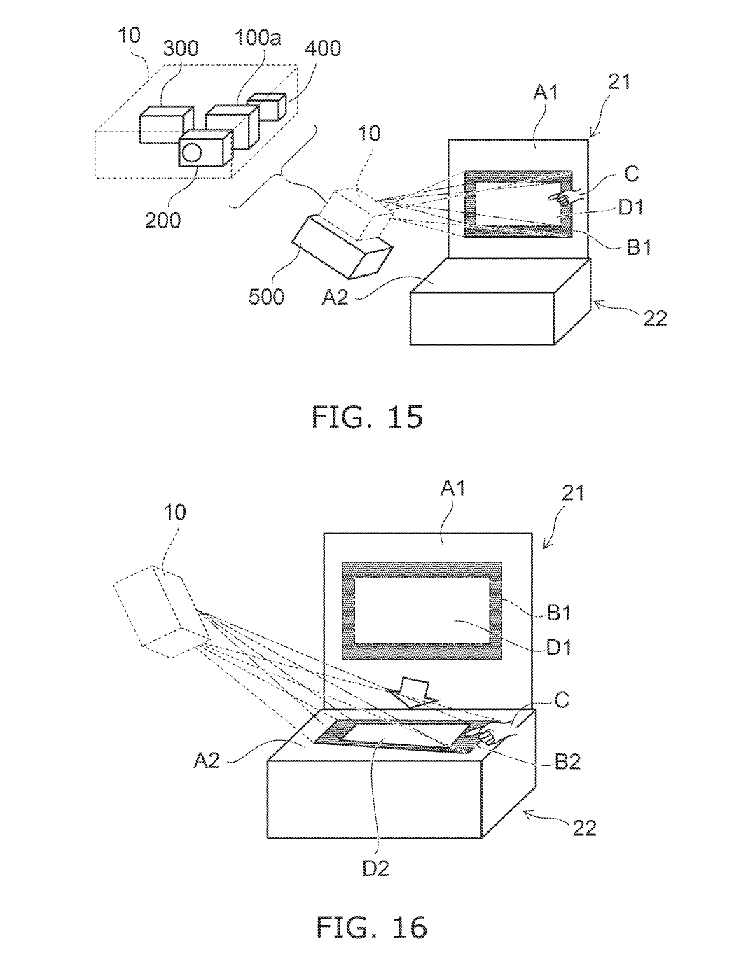

For instance, as shown in FIG. 15, the information processing device 100a, the distance sensor 200, the controller 300, and the image inputter 400 may be included in one casing 10. For instance, the casing 10 may be fixed to the display 500.

The information processing device 100a can be e.g. LSI or IC. The information processing device 100a may be incorporated in a projector including e.g. the image inputter 400 and the display 500. The embodiment may be an image projection device (projector) including the information processing device 100a and the display 500.

The information processing device 100a may be provided separately from the projector. The information processing device 100a may be a dedicated or general-purpose processor. The information processing device 100a may be e.g. a processor included in the controller 300 (e.g., computer). Part of the functional blocks of the information processing device 100a may be incorporated in the projector as an integrated circuit. Part of the functional blocks of the information processing device 100a may be based on separate processors.

In the following description, it is assumed that the display 500 is a projector.

As shown in FIG. 14, the display 500 projects an image converted by the image converter 150 on an arbitrary object surface. The object 21 or 22 includes a projection surface (e.g., surface A1 or A2) on which the image is projected. The projection range D1 represents the range of the image projected on the projection surface. The distance sensor 200 measures the distance to at least part of the projection surface. The second distance information d(x,y,t) is based on the distance between the distance sensor 200 and at least part of the projection surface.

FIG. 16 shows the state in which the position posture of the casing 10 has changed. The projection range D1 changes to a projection range D2 with the change of the position posture of the casing 10. For instance, this may distort the projection image.

The image converter 150 determines the shape of the object surface, i.e., the projection target, based on the reference distance D₀(x,y) stored by the storage 140. Based on the shape of the object surface, the image converter 150 predicts the distortion occurring at the time of projection, and converts the image so as to remove the distortion. The image converter 150 uses the reference distance D₀(x,y) rather than the distance information acquired by the distance sensor 200. Thus, the image converter 150 can ignore the distance change due to operation and remove the distortion corresponding to the position/shape change of the object surface.

The deformation for removing the distortion of the projection image can be performed using two-pass rendering. In two-pass rendering, the position of a viewpoint for observing the projection image is predetermined. The projection image is deformed so that an image without distortion can be observed at the viewpoint. First, a projector is virtually placed at the predetermined viewpoint position to generate an image obtained by observing the projection image at the position of an actual projector. This generation is possible if internal information such as angle of view and resolution of the projector, and the shape of the projection surface (shape of the object surface) are known. The generated image can be regarded as a reverse-distorted image. Thus, an image free from distortion is observed at the predetermined viewpoint position when the generated image is projected from the actual projector.

The shape of the projection surface is calculated based on the distance information acquired by the distance sensor 200. However, the distance sensor 200 continuously acquires distance information. Thus, if the image converter 150 updates the image conversion result based on the continuously acquired distance information, the shape of the image is changed also by the change of the distance due to the pointer C. Specifically, when a hand is brought close for the purpose of operation, the image conversion result changes with the motion of the hand. This affects the image quality. Furthermore, in the case of assuming a touch operation for pushing e.g. a button, the display position of the button moves with the motion of the hand. This hampers the operation.

In contrast, in this embodiment, the image converter 150 calculates the shape of the projection surface based on the reference distance D₀(x,y). This can suppress the change of the image during operation.

In the case where the projection surface is flat, a simple trapezoidal distortion occurs. Thus, the distortion can be removed by the existing trapezoidal correction without using two-pass rendering. The shape of the projection surface is known. This allows easy determination of parameters necessary for trapezoidal correction. For instance, the relative angle between the projector and the projection surface is found by calculating the normal to the projection surface based on the reference distance. This angle is used to perform trapezoidal correction.

As in the first embodiment and the second embodiment, the operation detector 120 detects an operation based on the reference distance D₀(x,y) and the second distance information d(x,y,t). In this embodiment, the operation detector 120 converts the coordinates in accordance with the projected image and transmits them to the controller 300. For instance, the projection image can be operated as on a touch display by detecting a touch operation on the projected image.

For conversion of coordinates, for instance, the coordinates of the operation acquired in the coordinate system of the distance sensor 200 are restored to a three-dimensional point. Then, the three-dimensional point is projected on the coordinate system of the projector. These conversions need internal parameters representing e.g. the angle of view of the distance sensor 200 and the projector, and external parameters representing the difference in position posture between the distance sensor 200 and the projector. These parameters (internal parameters and external parameters) are invariant if the projector and the distance sensor 200 are fixed. Thus, it is only necessary to previously calibrate these parameters once. The method for converting coordinates is not limited thereto, but any method may be used.

The reference distance referred to by the operation detector 120 may be different from the reference distance referred to by the image converter 150. For instance, the first distance information includes a first reference distance and a second reference distance. The operation detector 120 detects an operation by the pointer C based on the first reference distance. The image converter 150 converts the image based on the second reference distance. The updater 130 updates the first reference distance during a first period. The updater 130 updates the second reference distance during a second period different from the first period.

This embodiment can convert an image in order to display the image on an arbitrary object surface without distortion, and detect an operation on the displayed image. Furthermore, this embodiment can suppress unnecessary change of the projection image at the time of operation by a pointer. Thus, the information processing device 100a according to this embodiment can improve the stability of the detection of operations. In other words, the information processing device 100a according to this embodiment can provide a stabler operation to the user.

### Fourth Embodiment

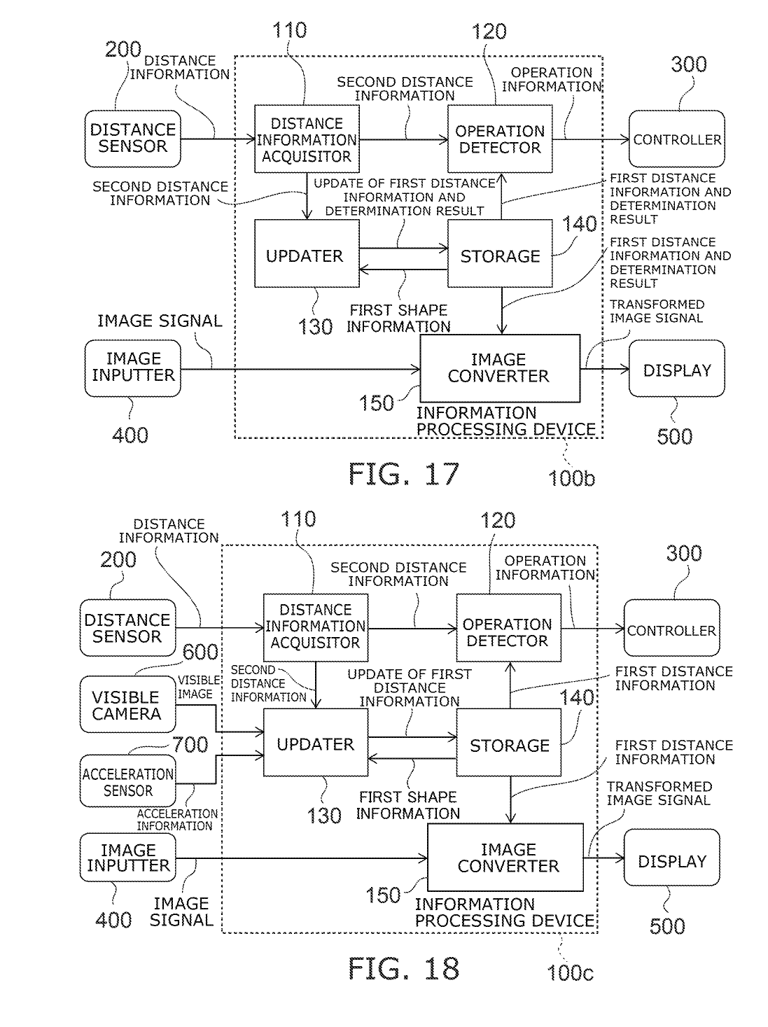

FIG. 17 is a block diagram showing an information processing device.

This embodiment relates to an information processing device for deforming an image in order to display the image on an arbitrary object surface without distortion, and detecting an operation on the displayed image.

The information processing device 100b according to this embodiment is different from the information processing device 100, 100a according to the first to third embodiments in that the storage 140 further stores the determination result of the determiner 131. The updater 130 updates the determination result stored by the storage 140.

When the update condition of the reference distance is significantly violated, the updater 130 does not update the reference distance. Furthermore, it may be more favorable to prevent malfunctions by stopping the detection of operations by the operation detector 120 or stopping the conversion of the image by the image converter 150. Thus, in this embodiment, each of the operation detector 120 and the image converter 150 further includes the function of determining whether to stop processing based on the determination result stored by the storage 140. For instance, the operation detector 120 switches the state of detecting operations by the pointer C based on the determination result stored by the storage 140. For instance, the image converter 150 switches the state of converting the image based on the determination result stored by the storage 140.

For instance, when the determination result stored by the storage 140 remains unsuitable to update for a relatively long time, each of the operation detector 120 and the image converter 150 can prevent malfunctions by stopping processing. Stopping of processing by each of the operation detector 120 and the image converter 150 may be signaled to the user by e.g. an image.

### Fifth Embodiment

FIG. 18 is a block diagram showing an information processing device.

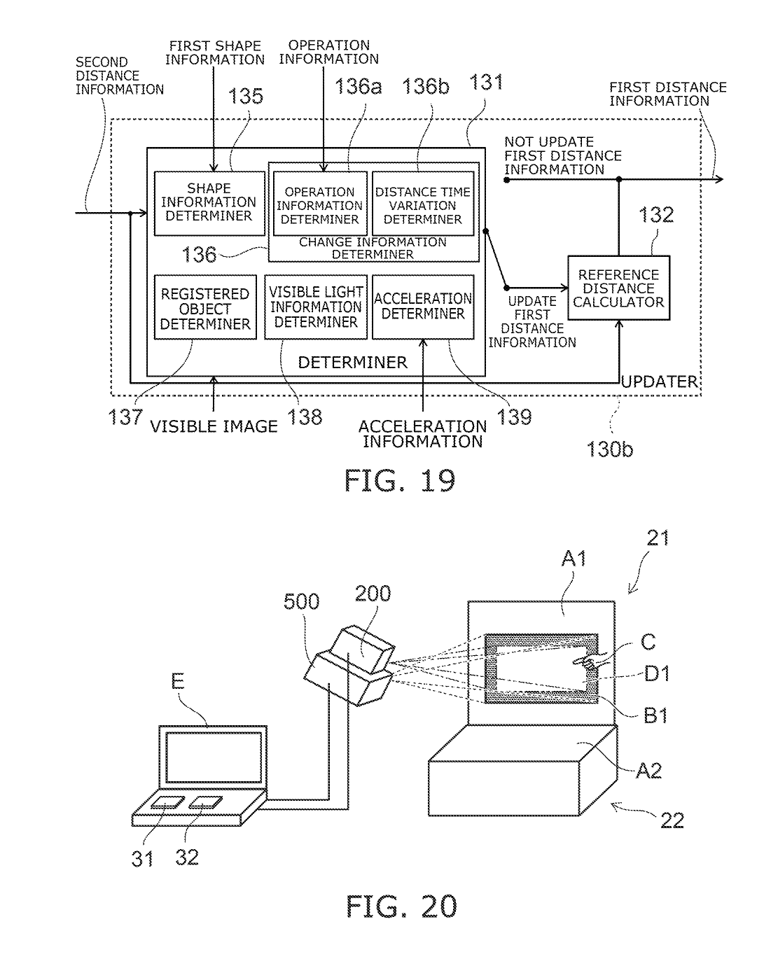

FIG. 19 is a block diagram showing an updater.

This embodiment relates to an information processing device for deforming an image in order to display the image on an arbitrary object surface without distortion, and detecting an operation on the displayed image.

The information processing device 100c according to this embodiment is different from the information processing device 100, 100a, 100b according to the first to fourth embodiments in further including a visible camera 600 and an acceleration sensor 700. This embodiment is described assuming that the information processing device 100c includes both the visible camera 600 and the acceleration sensor 700. However, the information processing device 100c according to this embodiment may include one of the visible camera 600 and the acceleration sensor 700.

The updater 130b of this embodiment is different from the updater 130, 130a of the first to fourth embodiments in further including a registered object determiner 137, a visible light information determiner 138, and an acceleration determiner 139. This embodiment is described assuming that the updater 130b includes all of the registered object determiner 137, the visible light information determiner 138, and the acceleration determiner 139. However, the updater 130b of this embodiment may include at least one of the visible light information determiner 138 and the acceleration determiner 139.

The registered object determiner 137 detects a pointer C such as a hand, finger, pointing bar, and electronic pen. The registered object determiner 137 determines whether to update the reference distance depending on whether the pointer C is detected. The detection method may be a method using the second distance information, or a method using information (visible image) of the visible camera 600. For instance, the registered object determiner 137 may perform detection based on the similarity between the information of the shape acquired from the second distance information and the information of the shape of the pointer C registered previously. The registered object determiner 137 may perform detection using information on luminance/color based on the information of the visible camera 600. In the case where a marker may be attached to the pointer C, the registered object determiner 137 may detect the marker.

The visible light information determiner 138 determines whether to update the reference distance based on information on visible light on the object surface, i.e., the color and brightness of the object surface. For instance, the visible light information determiner 138 updates the reference distance when the brightness of the object surface is more than or equal to a certain brightness. Alternatively, the visible light information determiner 138 updates the reference distance when the chroma of the object surface is less than or equal to a certain chroma.

The acceleration determiner 139 determines whether to update the reference distance based on the value of the acceleration sensor 700 (acceleration information). For instance, the acceleration sensor 700 responds to the motion of the casing 10. Thus, the condition for updating the reference distance may be configured so that it is not satisfied when the value of the acceleration sensor 700 is higher than a prescribed threshold, and it is satisfied when the value of the acceleration sensor 700 is less than or equal to the prescribed threshold. However, the acceleration determiner 139 cannot determine the change of the position of the projection surface. Thus, it is more preferable to use the acceleration determiner 139 in combination with the distance time variation determiner 136b described above with reference to FIG. 10.

This embodiment can determine whether to update the reference distance more robustly by additional sensors.

### Sixth Embodiment

In this embodiment, the information processing devices according to some embodiments are implemented by a program on a computer. For convenience, this embodiment is described assuming an operation similar to that of the information processing device 100a according to the third embodiment.

FIG. 20 is a schematic perspective view illustrating an example of the information processing device in use.

In this example, the computer E is connected to the distance sensor 200 and the display 500. In this embodiment, the display 500 is a projector. The computer E includes a processor 31 and a storage device 32. The storage device 32 is e.g. a hard disk. However, the storage device 32 may be a storage medium such as CD, DVD, or flash memory. For instance, the storage device 32 stores a program for implementing the information processing device 100a. For instance, the program is acquired through a storage medium or network, and appropriately installed on the computer E. The program is executed by the processor 31 to perform processing in the information processing device 100a. For instance, the storage device 32 is used also as a buffer for holding the distance information.

In this embodiment, the distance information is inputted from the distance sensor 200 to the computer E and passed to the information processing device 100a. The inputted image is an image file or video file held by the computer E. The desktop screen of the computer E may be used as an input. The operation information detected by the operation detector 120 is outputted to the operating system (OS) on the computer E. Thus, an event such as a click, tap, flick, and zoom is issued. The converted image is sent to the display 500 and projected.

In this embodiment, the information processing device can be implemented by combining a distance sensor, a projector, and a computer. Thus, there is no need of dedicated hardware. This has the advantage of reducing the introduction cost.

The embodiments can provide an information processing device for detecting operations by a pointer in which the reference distance can be updated more favorably. Thus, the embodiments can provide an information processing device in which the stability of detection is improved.

Hereinabove, embodiments of the invention are described with reference to specific examples. However, the invention is not limited to these specific examples. For example, one skilled in the art may similarly practice the invention by appropriately selecting specific configurations of components such as the distance information acquisitor, the operation detector, the updater, the storage, the reference distance, the distance information, the pointer, the image converter, the distance sensor, the display, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all information processing devices, image projection devices, information processing methods, the non-transitory recording mediums practicable by an appropriate design modification by one skilled in the art based on the information processing device, the image projection device, the information processing method, the non-transitory recording medium described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An information processing device comprising:
a storage configured to store first distance information indicating a distance between a reference point and a first surface and first shape information indicating a surface shape of the first surface; and
a circuit configured to
acquire a second distance information indicating a distance between the reference point and an object;
determine if an operation inputted by user is present or absent by using the second distance information;
determine whether a first condition is satisfied or not by comparing the first shape information with second shape information; and
update the first distance information based on the second distance information when the operation is determined to be absent and the first condition is determined to be satisfied.

2. The device according to claim 1, wherein the circuit detects the operation based on the first distance information and the second distance information.

3. The device according to claim 1, wherein the circuit acquires the second distance information at specific time intervals.

4. The device according to claim 1, wherein the first condition relates to a degree of similarity between the first shape information and the second shape information.

5. The device according to claim 1, wherein
the first shape information includes a threshold,
the second shape information includes a flatness of a surface of an object calculated based on the second distance information, and
the circuit updates the first distance information when the flatness is higher than the threshold.

6. The device according to claim 1, wherein
the first surface is provided in a plurality,
the object includes a multiple planes,
the first shape information includes a number of the first surfaces,
the second shape information includes a number of second surfaces based on the multiple planes, and
the circuit updates the first distance information when the number of the second surfaces is less than or equal to the number of the first surfaces.

7. The device according to claim 1, wherein the circuit updates the first distance information based on temporal change in the distance between the reference point and the object.

8. The device according to claim 1, wherein the first surface includes a projection surface on which an image is projected.

9. The device according to claim 2, wherein
the storage further stores a determination result indicating if the operation inputted by user is present or absent, and
the circuit determines whether to terminate detecting the operation inputted by user or not based on the determination result.

10. The device according to claim 9, wherein
the circuit converts an inputted image based on the first distance information.

11. The device according to claim 10, wherein
the first distance information further includes a first reference distance and a second reference distance,
the circuit detects the operation based on the first reference distance, converts the inputted image based on the second reference distance, and updates the first reference distance and the second reference distance at different times.

12. The device according to claim 10, wherein the circuit determines whether to convert the inputted image or not based on the determination result stored by the storage.

13. The device according to claim 1, wherein
the first shape information includes a first point cloud data of a surface of the object measured previously,
the second shape information includes a second point cloud data of the surface of the object calculated based on the second distance information, and
the circuit updates the first distance information when similarity in shape between the first point cloud data and the second point cloud data is more than or equal to a threshold.

14. The device according to claim 1, wherein the circuit does not update the first distance information when the operation is determined to be present.

15. The device according to claim 1, wherein the circuit updates the first distance information based on the second distance information when the operation is determined to be absent.

16. The device according to claim 1, further comprising:
a sensor to measure a distance between the reference point and the first surface,
wherein the second distance information is based on a distance between the sensor and the first surface.

17. An image projection device comprising:
an information processing device according to claim 1; and
a projector to project an image on the first surface.

18. An information processing method comprising:
storing first distance information indicating a distance between a reference point and a first surface and first shape information indicating a surface shape of the first surface;
acquiring second distance information indicating a distance between the reference point and an object;
determining if an operation inputted by user is present or absent by using the second distance information;
determining whether a first condition is satisfied or not by comparing the first shape information with second shape information; and
updating the first distance information based on the second distance information when the operation is determined to be absent and the first condition is determined to be satisfied.
